(19) United States
(12) Patent Application Publication
(10) Pub. No.: US 2003/0126606 A1
(43) Pub. Date: Jul. 3, 2003

(54) Hierarchical decision fusion of recommender scores

(75) Inventors: Anna L. Buczak, Briarcliff Manor, NY (US); J. David Schaffer, Wappingers Falls, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Esectronics N.V., New York City, NY (US)

(21) Appl. No.: 10/029,830

(22) Filed: Dec. 27, 2001

(51) Int. Cl. G06F 3/00; H04N 5/445

(52) U.S. Cl. 725/46; 725/48

(57) ABSTRACT

A method and system for providing hierarchical decision fusion of recommender scores, wherein at least two levels of fusion are provided. In a method, a plurality of recommenders at a first level are grouped according to topics of interest. A plurality of first level fusion centers receive a number of outputs from a predetermined number of recommenders. The first level fusion centers output a first enhanced decision level, and a series of second level fusion centers receive a predetermined number of the first enhanced decision, and a second fusing step occurs to result in a second enhanced decision level. The groups can be reading history, music, viewing history, purchasing history, and can be intermixed, so that the enhanced decision may recommend a particular movie based on both the ranking about movies and music.

### BACKGROUND OF THE INVENTION

1. Field of the Invention

The present invention relates to recommender systems and the fusion of recommender scores in a hierarchical fashion. More particularly, the present invention relates to a combination function for multiple recommendation agents.

2. Description of the Related Art

Recommender systems are known in the prior art to provide a user with a series of choices in a particular category or field in which the user has expressed interest. For example, content-based recommender systems may suggest documents, items, and/or services to a user or users based upon a heuristic profile of rated items which were selected (or passed over) by the user. There are text marking systems which can obtain information about selected items and use the information to provide recommendations which are based on the similarity of information of the previously selected items and the recommended items.

It is disclosed in the book Recommending Using Text Categorization with Extracted Information, by Raymond J. Mooney, Paul N. Bennett and Lorene Roy, AAAI-98/ICML-98 Workshop on Learning for Text Categorization (1998) that recommender systems generally make recommendations using a form of computerized matchmaking called collaborative filtering for recommendations of music and films. In these systems, user's tastes are matched with other users having a significant correlation with their preferences. The profiles these systems maintain are often just lists of selected (and sometimes also rejected) items.

A second approach to recommendations is to use only a given user's preferences and do not compare them with other users' preferences (so no collaborative filtering is performed). For users concerned with their privacy, this is the preferred way of performing recommendations. In this case, only viewing/reading/listening histories of the given individual can be used in order to infer the recommendations for the future. Different techniques can be used for generating recommendations based on viewing histories, such as Bayesian, Decision Trees, and nearest neighbor classifiers. All of these techniques provide a type of ranking with regard to the probability that a recommendation will conform to a viewer's taste.

When there are available recommendations for the same items from multiple recommenders (profiles), one-step fusion methods are available, such as disclosed by Meuleman in Stereotype and Role Model Agents in Distributed User Profiles. There is no multi-step fusion scheme for the aggregation of multiple recommendations in the prior art.

If in addition to multiple profiles for a given set of items (say TV shows), one has available also multiple profiles for a different set of items (say music recordings) and one wishes to use these profiles to augment/refine the recommendations of the first set of items, then there is a need for a fusion operation that is unlike the one-step methods in the prior art; there is a need for a multi-step fusion operation that applies different fusion methods at each step.

### SUMMARY OF THE INVENTION

The present invention exploits the three facts that (1) it is most natural to build user profiles for different content domains using examples of content and user interfaces explicitly geared to those different domains, that (2) there are useful overlaps between domains that can be exploited to improve the recommendations and that (3) a hierarchical fusion technique is the most flexible one in providing the final recommendation.

For instance, a profile of one's interests in TV shows is most naturally built with references only to TV shows and similarly for books and music (recorded, or broadcast by radio or internet). Yet, for example, a person who shows generally low interest in biographical TV shows will likely show more interest in a show on a person who has authored several books recently purchased. The success of this approach depends on the presence of certain important features in the metadata of these different domains. Combining these bits of information across domains is possible in one fusion step. However additional flexibility, leading to better prediction accuracy, can be obtained using hierarchical methods.

The present invention is a method and system that obtains recommendations about different areas and/or topics which interest the user by hierarchical fusion from a plurality of recommenders. U.S. patent application Ser. No. 09/627,139 (filed Jul. 27, 2000) by Schaffer et al., which is hereby incorporated by reference as background material for this application, discloses a Three-Way Media Recommendation Method and System combining an implicit (history) profile, a feedback profile and an explicit profile to generate new predictions, which can then be combined by, for example, weight-averaging. However, the present invention provides a hierarchical fusion heretofore unknown in the art.

A method for providing hierarchical fusion of recommender scores comprises the steps of:

(a) providing a plurality of recommenders at a first level, said recommenders being grouped to at least one of a plurality of predetermined groups according to topics of interest;

(b) providing a predetermined number of first level fusion centers for receiving an output from each of said recommenders from at least one particular group;

(c) outputting a decision by each one of said plurality of recommenders grouped in step (a) to a respective first level fusion center, wherein each decision provides a recommendation;

(d) each respective first level fusion center performing a first fusing step of the decisions output in step (c) by said recommenders from said at least one particular group;

(e) each respective first level fusion center outputting a first enhanced decision based on the fusion performed in step (d),

(f) providing a plurality of second level fusion centers for receiving the first enhanced decisions output from a group of said first level fusion centers;

(g) each respective second level fusion center performing a second fusing step of the first enhanced decisions received from the group of said first level fusion centers; and

(h) each respective second level fusion center outputting a second enhanced decision and

(i) outputting to a user a finally enhanced decision chosen from the enhanced decisions in step (h).

It is understood by persons of ordinary skill in the art that the present invention covers more than two levels of fusion and can be applicable to more than a single recommendation.

### BRIEF DESCRIPTION OF THE DRAWINGS

FIG. 1A is an overview of the hierarchy of the method and system according to the present invention.

FIG. 1B is another example of the hierarchy of the method and system according to the present invention.

FIG. 1C is a flowchart of an embodiment of the present invention having two hierarchical levels.

FIG. 2 is an illustration of a system according to the present invention.

### DETAILED DESCRIPTION OF THE INVENTION

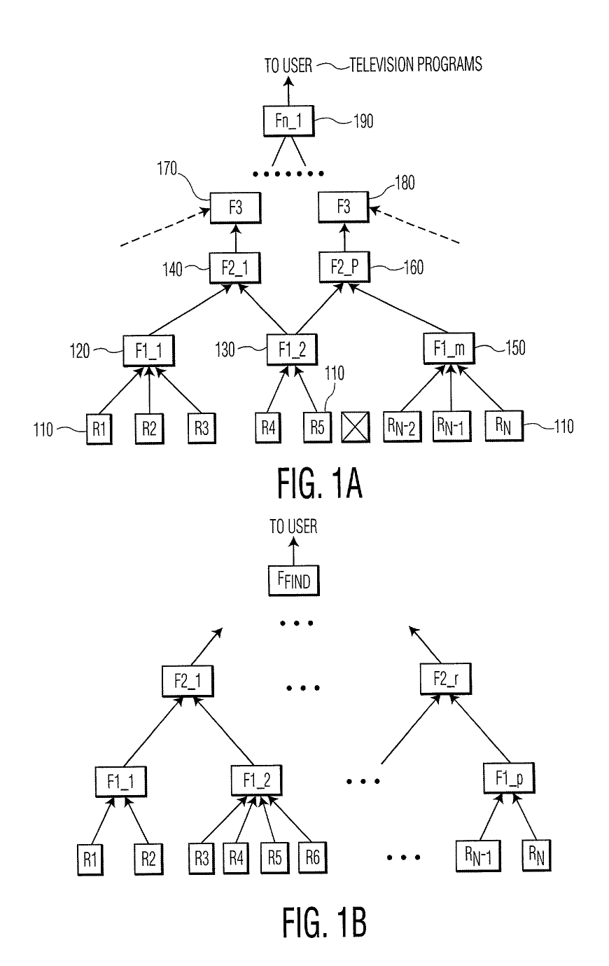

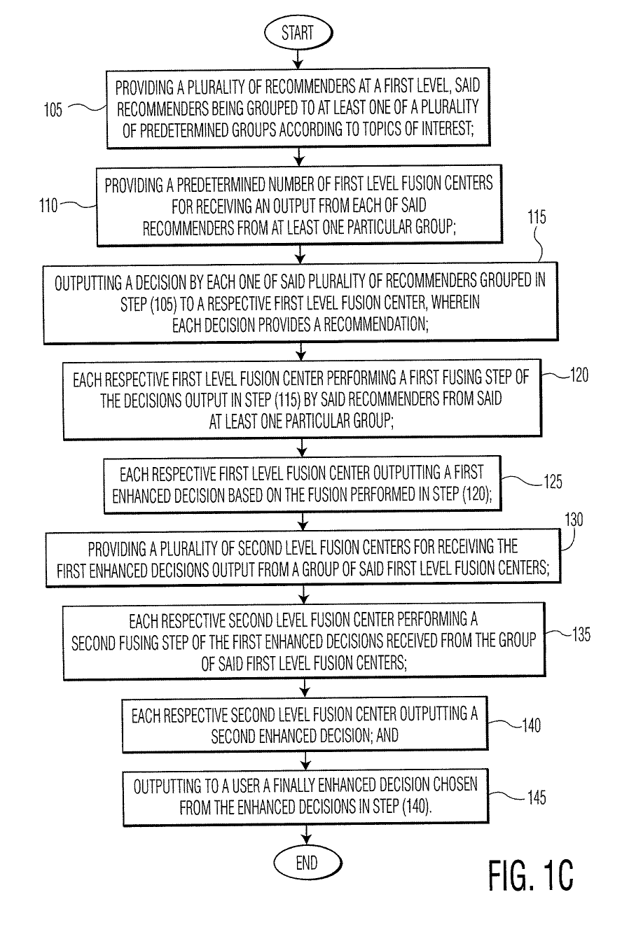

FIG. 1A illustrates an overview of the hierarchy of the present invention. As shown in FIG. 1A, there is a hierarchy including a plurality of recommenders 110 (R₁ through Rₙ). Each of the recommenders makes recommendations about specific areas of interest. For example, recommenders R₁, R₂ and R₃ may be television program recommenders employing different recommendation mechanisms.

The decisions of the recommenders R₁, R₂ and R₃ are fused together by a first level fusion center 120 (F1_1). The first level fusion center may, for example, employ a voting scheme to decide the final recommendation out of input recommendations R₁, R₂ and R₃.

Similar to the above, recommenders R₄ and R₅ are fused together by another first level fusion center 130 (F1_2). However, unlike the specific areas of interest with regard to television programming recommended by the recommenders R₁, R₂ and R₃, the recommenders R₄ and R₅ may have been derived to recommend, for example, different types of music. The final recommendation of the system (at the last level of hierarchy) being a TV program recommendation, R₄ and R₅ will be used in the system to detect features of preferred music in TV shows. They can be seen as rating the musical part of the TV show. The first level fusion center 130 (F1-2) thus provides a recommendation for TV shows from the perspective of the user's musical preferences of a given show, whereas the fusion center 120 provides a television recommendation from the perspective of the user's TV show preferences. Fusion center 130 may employ (rather than a voting scheme) a neural network to perform fusion between the recommenders R₄ and R₅.

A second level fusion center 140 (F2_1) combines the decisions from the fusion center 120 and 130, which may result, for example, in an enhanced television program recommendation. The enhancement, for example, may be based on the fact that the music recommenders indicate that the user prefers rock and roll music from the 1960's, and one of the television programs from R₁, R₂ and R₃ may be about a particular rock band from that era, or one of the shows may have background music related to that era. Thus, the fusion of the television recommenders and the music recommenders provides an enhanced recommendation because of the additional information fusion.

In addition, recommenders Rₙ₋₂, Rₙ₋₁ and Rₙ for example, may recommend television programs, for example, based on the user's personal library, book purchases, and public library borrowings. The first level fusion center 150 (F1_M) combines the outputs to get an enhanced television recommendation. One way that fusion center 150 could operate is by the use of voting.

In addition another second level fusion center 160 (F2_P) would fuse the output recommended by fusion center 150 and at least one other fusion center 130. The second level fusion center 160 would make a recommendation with regard to a television show, which even further enhances the recommendation made, for example, by the fusion center 150.

The second level fusion centers, 140, 160, in turn may further enhance the recommendation. Third level fusion centers 170, 180 will in turn continue the hierarchy. There can be n levels of fusion centers, with n being a predetermined value of the complexity of the recommendation system. As the number of levels of fusion centers increases, the more complex will be the system.

Finally, an nth level 190 (Fn_1) will be the highest-level fusion center which may provide the most enhanced television recommendation. The hierarchy may not need to be utilized up to the nth level in all cases. For example, if a recommendation score is within a certain predefined range at a lower level, (for example) the second level of fusion centers, the recommendation can be made to the user without the necessity of utilizing the system resources associated with having the highest level fusion center provide the recommendation. This flexibility can be advantageous when a recommender system is making recommendations to a plurality of users during at least a partially overlapping period.

It should be noted that there is no one particular fusion method that must or should be used. For example, weighted averages, voting, neural networks, and Dempter-Shaffer Evidential Reasoning, are just a few of the many fusion methods known to persons of ordinary skill in the art that can be used with the hierarchical fusion. Furthermore, it is expected that the methods for fusing recommendations for domain A from recommenders derived for domain B will be different from the methods used for fusing recommendations for domain B from recommenders derived for domain A. Hence, there will be a different hierarchy for each domain of final recommendations.

FIG. 1B illustrates another aspect of the present invention. The final recommendation in this case (F Final) could be a music recommendation. The hierarchy on FIG. 1B is similar to that on FIG. 1A but different, in the sense that when the final recommendation is of a different type (e.g. music versus TV), the fusion hierarchy could be (and usually is) different. R1, R2 could have been derived to recommend, for example, different types of TV shows. The final recommendation of the system being a music recommendation, R1 and R2 will be used in the system to recommend music based on TV viewing history. Ri could provide that recommendation using a neural network and R2 using a Bayes classifier. R3, R4, R5 and R6 could be different music recommenders. Each of the music recommenders can be based on different listening history (e.g. CDs listened to, music from the radio listened to) or could be based on the same history but use different recommendation mechanisms (e.g. Bayesian, Decision Tree, neural network).

It is understood by persons of ordinary skill in the art that the classification of different items of interest could be, for example, classified by Bayes' optimal classifier, linear classifiers, quadratic classifiers, the k-nearest neighbor classifier, artificial neural networks, and so on.

It is also within the spirit and scope of the invention that the recommendations could be commercially weighted as well. For example, a more profitable item within a category (for example, a particular book having a higher mark up than comparable books in the area of interest) could be weighted so that it is offered before similar products/services in a particular category. In addition, payment from the producer of the goods or services might also increase its weight and/or give it priority in the determination of the highest recommended scores.

FIG. 1C is a flowchart illustrating one possible way that the method according to the present invention can be practiced. It is understood by persons of ordinary skill in the art that only two hierarchical levels are used in the flowchart for explanatory purposes, but the use of more than two levels are within the spirit of the invention and the scope of the appended claims.

At step 105, a plurality of recommenders are provided at a first level.

At step 110, a predetermined number of first level fusion centers are providing. Each of the fusion centers can receive a number of outputs (called decisions) from the recommenders which are grouped together by area/topics of interest.

At step 115, the first level fusion centers receive the outputs from the recommenders.

At step 120, a fusing step is performed which fuses the recommendation of more than one decision from the recommenders.

At step 125, each first level fusing center outputs an enhanced decision based on the fusion performed in step 120.

At step 130, a plurality of second level fusion centers are provided for receiving the first enhanced output decisions.

At step 135, a second fusing step is performed so that the first enhanced decisions are selectively fused together to form a second enhanced decision.

At step 140, each of the second level fusion center outputs the second enhanced decision.

(Again, it should be understood that there might be more than 2 levels of fusion).

At step 145, the final enhanced decision is output to the user.

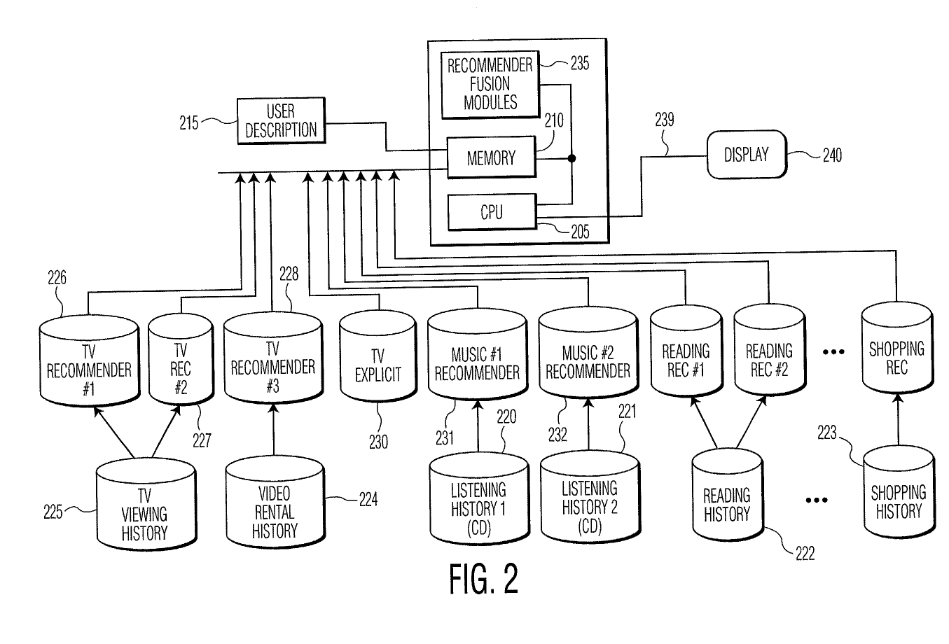

FIG. 2. illustrates hardware that can be used to implement the present invention. For purposes of illustration and not limitation, it is understood by persons of ordinary skill in the art that while the illustration embodies one way for explanatory purposes, there are many possible variations of the illustration which are within the spirit of the invention and the scope of the appended claims.

A recommender system 200 shown in FIG. 2 includes a central processing unit 205, and a memory 210 (typically but not limited to ROM, RAM, DRAM, etc.). In an embodiment, it is envisioned that the recommender system could be a server, which would, inter alia, register users, manage user groups, allow category ratings, and provide filtering. The protocol may be open. In addition, it is within the spirit and scope of the invention that although one cpu is shown, parallel processing techniques may be employed to fuse the different topics of interest at or near the same time along different areas of the hierarchy. It should be understood that the whole recommender system could be on a TV set, not only on a computer.

The memory 210 may contain information regarding a user description 215, such as address, zip code, age, educational background, occupation, and income, preferences for TV show features, music features, etc.. This information may be stored in memory 210 locally, or it can be information stored in a database that is accessed over telephone lines, fiber optic lines, LAN/WAN, on a server accessed over the Internet, etc. The user may have an identifying code which would allow the cpu to access the user profile. In the case of the Internet, there can be a cookie on the user's hard drive. Alternately, the user could be asked to supply a password or sign-on name which has been previously registered. Any known identification scheme can be used, so long as there is a means for the cpu to be able to retrieve the user description and/or past history based on the identifier.

In addition to or in lieu of the user description, the cpu may obtain historical data and/or access an explicit profile of user selected likes and dislikes with regard to a plurality of subjects, such as movies, music, theatre, arts, sports, politics, romance, finance, technology.

In FIG. 2, there is shown historical data such as listening history for radio 220, listening history for compact discs 221, reading history 222, shopping history 223, video rental history 224 and television viewing history 225. These histories can be compilations of past selections using the recommender system, or they may be a composite based on the user's preferences. In addition, it is possible that customer lists can also be obtained. For example, a user's purchasing history from a particular book store, the rental history from a video store, the type of car that the user owns, all could be part of the composite. In addition, it would even be possible to categorize purchases made with charge cards (as done by, for example, by certain credit card companies in the form of a year end statement that is grouped into types of purchases).

The histories are used by recommenders for a recommendation. For example television recommender (#1) 226 and television recommender (#2) 227 examine television viewing history 225. However, television recommender (#3) 228 examines video rental history 224, but television recommender 230 is explicit, meaning the recommendation is based on preferences actively entered by the viewer.

In addition, music recommender (#1) 231 examines listening history for radio 220, but music recommender (#2) 232 examines listening history for compact discs 221. The reading recommenders and the shopping recommenders similarly examine histories, or are based on explicit preferences from the user, as the case may be.

It is also envisioned that a recommender module 235 would include software that would perform the fusion of the different topics of recommendation from recommenders 226,227,228,230,231,232, etc. It is understood by persons of ordinary skill in the art that the module may include a neural network and hierarchically fuse the decision from the different recommenders. This module can be adapted for execution under any known operating system.

A user display 240 will receive the recommendation from the recommender system, and the display may not be part of the system. For example, the display could be a user's personal computer, or an interactive television screen, telephone, electronic communicator, etc. The display can be remotely controlled. In addition, the user display may communicate with the system 200 by wire, wireless, fiber optic, microwave, RF, LAN/WAN, and Internet just to name some of the possible ways that they can be linked. The recommendations may not even be shown to the user, but may be used to drive certain automatic actions, for example, automatically recording most desirable shows.

Various modifications may be made by person of ordinary skill in the art, which is within the spirit of the invention and the scope of the appended claims. For example, the type of fusion decision can be made different fusion methods, the values applied to the different items can be determined according to need.

What is claimed is:

1. A method for providing hierarchical decision fusion of recommender scores, said method comprising the steps of:
(a) providing a plurality of recommenders at a first level, said recommenders being grouped to at least one of a plurality of predetermined groups;
(b) providing a predetermined number of first level fusion centers for receiving an output from each of said recommenders from at least one particular group;
(c) outputting a decision by each one of said plurality of recommenders grouped in step (a) to a respective first level fusion center, wherein each decision provides a recommendation;
(d) each respective first level fusion center performing a first fusing step of the decisions output in step (c) by said recommenders from said at least one particular group;
(e) each respective first level fusion center outputting a first enhanced decision based on the fusion performed in step (d);
(f) providing a plurality of second level fusion centers for receiving the first enhanced decisions output from a group of said first level fusion centers;
(g) each respective second level fusion center performing a second fusing step of the first enhanced decisions received from the group of said first level fusion centers;
(h) each respective second level fusion center outputting a second enhanced decision; and
(i) outputting to a user a finally enhanced decision chosen from the enhanced decisions in step (h).

2. The method according to claim 1, wherein the plurality of recommenders provided in step (a) have overlapping topics of interest.

3. The method according to claim 2, wherein the user's profile contains a plurality of preferences previously recorded.

4. The method according to claim 3, wherein the previously recorded preferences comprise one of a viewing history, listening history, and literary history.

5. The method according to claim 1, wherein the first fusing step recited in step (d) is performed by one of weighted average, voting, neural network, and Dempster-Shaffer Evidential Reasoning.

6. The method according to claim 1, wherein the second fusing step recited in step (g) is performed by one of weighted average, voting, neural network, and Dempster-Shaffer Evidential Reasoning.

7. The method according to claim 1, wherein step (h) further comprises (i) providing a plurality of third level fusion centers for receiving the second enhanced decisions from the second level of fusion centers, and (ii) each of the plurality of third level fusion centers performing a third fusing step of a predetermined number of second enhanced decisions.

8. The method according to claim 6, wherein step (h) further comprises (i) providing a plurality of third level fusion centers for receiving the second enhanced decisions from the second level of fusion centers, and (ii) each of the plurality of third level fusion centers performing a third fusing step of a predetermined number of second enhanced decisions.

9. The method according to claim 7, wherein step (h) further comprises (iii) providing a single nth level fusion center, said nth level fusion center receiving decisions output from said second level of fusion centers; and (iv) providing an nth fusing step from the second enhanced decisions.

10. The method according to claim 8, wherein step (h) further comprises (iii) providing a single nth level fusion center, said nth level fusion center receiving decisions output from said second level of fusion centers; and (iv) providing an nth fusing step from the second enhanced decisions.

11. The method according to claim 9, wherein the nth level of fusion centers is a fourth level.

12. The method according to claim 8, further comprising providing a single nth level fusion center, said nth level fusion center receiving decisions from a plurality of n−1 level fusion centers, wherein said n−1 level fusion centers being a higher level than the third level of fusion centers.

13. The method according to claim 11, wherein the nth fusion step is performed by one of weighted average, voting, neural network, and Dempster-Shaffer Evidential Reasoning.

14. The method according to claim 11, wherein the finally enhanced step is output to the user via one of wire communication, wireless communication, fiber optics, LAN/WAN, and Internet.

15. A system for hierarchical decision fusion of recommender scores, said system comprising:
a central processing unit;
a memory in communication with said central processing unit;
a recommender module comprising fusion software for fusing recommendations of a predetermined number of groups;
means for outputting a recommendation to a user;
wherein said recommender module provides at least two levels of fusion, wherein a plurality of recommendations are fused at a first level to provide a plurality of first enhanced decisions, and said plurality of first enhanced decision are fused at a second level to provide a plurality of second enhanced decisions which are fewer in number than said first enhanced decisions.

16. The system according to claim 15, wherein said memory further comprises means for storage of at least one of a viewing history, reading history and listening history.

17. The system according to claim 15, wherein said means for outputting a recommendation to a user includes means for means for communication via one of wire communication, wireless communication, fiber optics, LAN/WAN and Internet.

18. The system according to claim 15, wherein said central processing unit comprises a network server.

19. The system according to claim 15, wherein said means for outputting a recommendation to a user includes a display.

20. The system according to claim 15, wherein said system includes means for storing a cookie on a user's storage device, said cookie containing an identifier of a user profile in said memory.

21. The system according to claim 19, wherein the display resides in a remote control.
